(19) United States
(12) Patent Application Publication
(10) Pub. No.: US 2007/0210714 A1
(43) Pub. Date: Sep. 13, 2007

(54) GLASS TUBES FOR LAMPS, METHOD FOR MANUFACTURING THE SAME, AND LAMPS

(75) Inventor: Takeshi KIJIMA, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/684,797

(22) Filed: Mar. 12, 2007

(30) Foreign Application Priority Data
Mar. 13, 2006 (JP) 2006-067774

(51) Int. Cl. H01J 61/30

(52) U.S. Cl. 313/634

(57) ABSTRACT

A glass tube for lamp includes: a tubular glass section having open ends; and a ceramics film that covers at least a portion of an inner surface of the glass section in an area that forms a light emission section of the lamp.

The entire disclosure of Japanese Patent Application No. 2006-067774, filed Mar. 13, 2006 is expressly incorporated by reference herein.

### BACKGROUND

1. Technical Field

The present invention relates to glass tubes for lamps and methods for manufacturing the same, and lamps.

2. Related Art

Quartz glass tubes are used as arc tubes of light emitting lamps that may be used for projectors or the like (for example, see JP-A-2005-309372). When quartz glass is exposed to high-temperatures, its glass state (amorphous) transforms to cristobalite (crystalline) state, in other words, devitrification occurs. In the case of quartz glass, devitrification normally occurs at 1150° C. or higher. However, for example, when an electrode material that is thermally evaporated adheres as an impurity to an inner surface of a quartz glass tube of a lamp, the temperature at which devitrification occurs (hereafter referred to as a “devitrification temperature”) may lower, and devitrification of quartz glass of the quartz glass tube may occur at a temperature below 1000° C. The lowered devitrification temperature may shorten the service life of the lamp.

### SUMMARY

In accordance with an advantage of some aspects of the invention, glass tubes for lamps and methods for manufacturing the same, which can extend the service life of the lamps, can be provided. Also, lamps that use the aforementioned glass tubes for lamps can be provided.

A glass tube for lamp in accordance with an embodiment of the invention includes: a tubular glass section that opens on both ends thereof and a ceramics film that covers at least a portion of an inner surface of the glass section in an area that forms a light emission section of the lamp.

In the glass tube for lamp described above, at least a portion of the inner surface of the glass section in an area that forms the light emission section of the lamp is covered by the ceramics film. As a result, adhesion of impurities to the inner surface of the glass section can be prevented, and the devitrification temperature of the glass section can be prevented from lowering. Accordingly, with the glass tube for lamp described above, the service life of the lamp can be extended.

In the glass tube for lamp in accordance with an aspect of the embodiment of the invention, the ceramics film may include at least one of a compound material of boron nitride and silicon nitride, a compound material of boron oxinitride and silicon oxinitride, magnesium oxide, and yttrium oxide.

In the glass tube for lamp in accordance with an aspect of the embodiment of the invention, the ceramics film may entirely cover the inner surface of the glass section at the area that forms the light emission section.

In the glass tube for lamp in accordance with an aspect of the embodiment of the invention, the glass section in the area that forms the light emission section has a diameter that may be greater than a diameter of the glass section on other areas.

In the glass tube for lamp in accordance with an aspect of the embodiment of the invention, the ceramics film may entirely cover the inner surface of the glass section in the other areas.

In the glass tube for lamp in accordance with an aspect of the embodiment of the invention, the ceramics film in the area that forms the light emission section has a film thickness that may be smaller than a film thickness of the glass section in the area that forms the light emission section.

A lamp in accordance with an embodiment of the invention has the glass tube for lamp described above.

A method for manufacturing a glass tube for lamp in accordance with an embodiment of the invention includes the steps of: preparing a tubular glass section that opens on both ends thereof; and forming by a CVD method a ceramics film that covers at least a portion of an inner surface of the glass section in an area that forms a light emission section of the lamp.

In the method for manufacturing a glass tube for lamp in accordance with an aspect of the embodiment of the invention, the CVD method may be a thermal CV method or a plasma CVI) method.

In the method for manufacturing a glass tube for lamp in accordance with an aspect of the embodiment of the invention, the CVD method may use at least one of bis (6-ethyl-2,2-dimethyl-3,5-decanodionate) magnesium, tris (sec-butylcyclopentadienyl) yttrium, and tris(trimethylsiloxy) borate as a raw material gas.

### BRIEF DESCRIPTION OF THE DRAWINGS

FIG. 1 is a perspective view (with a cross section in part thereof) schematically showing a lamp in accordance with an embodiment of the invention.

FIG. 2 is a cross-sectional view schematically showing a glass tube for lamp in accordance with an embodiment of the invention.

FIG. 3 is a cross-sectional view schematically showing a step of a method for manufacturing a glass tube for lamp in accordance with an embodiment of the invention.

FIG. 4 is a view schematically showing a step of the method for manufacturing a glass tube for lamp in accordance with the embodiment of the invention.

FIG. 5 is a view schematically showing an apparatus for manufacturing a glass tube for lamp in accordance with a modified example of the embodiment.

FIG. 6 is a view schematically showing an apparatus for manufacturing a glass tube for lamp in accordance with a modified example of the embodiment.

### DESCRIPTION OF EXEMPLARY EMBODIMENTS

Preferred embodiments of the invention are described below with reference to the accompanying drawings.

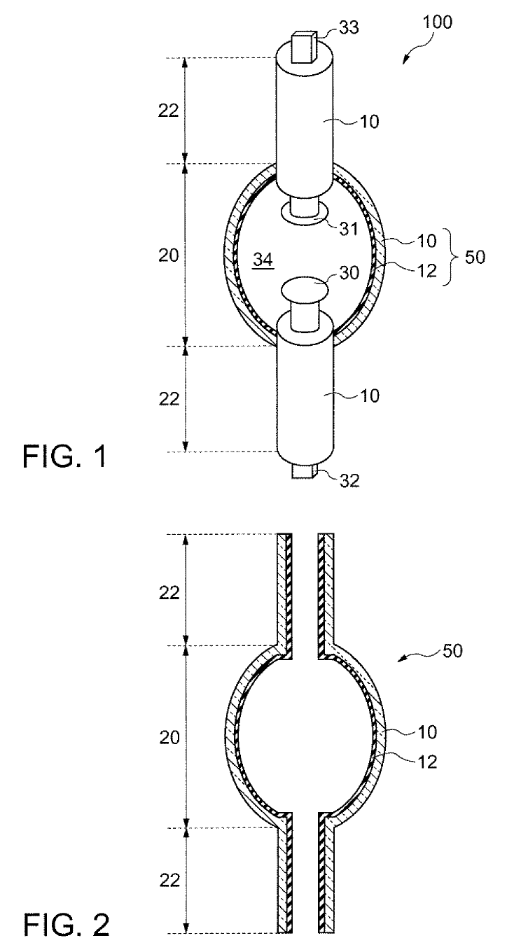

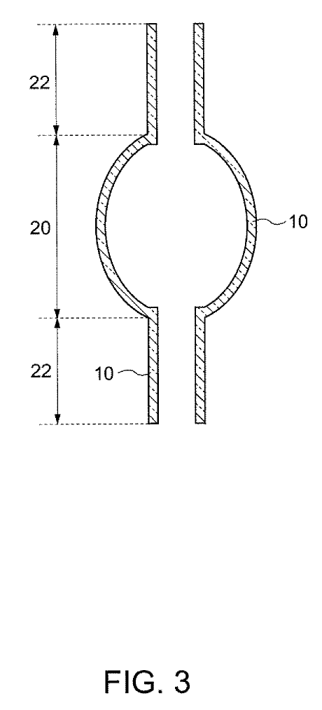

1. First, a lamp and a glass tube for the lamp in accordance with an embodiment of the invention are described. FIG. 1 is a perspective view schematically showing a lamp 100 in accordance with an embodiment of the invention, with a cross section in part of the lamp 100. FIG. 1 shows a cross section of a glass tube 50 of the lamp in a region that forms a light emission section (hereafter also referred to as a “first area”) 20. FIG. 2 is a cross-sectional view schematically showing the glass tube for lamp in accordance with the present embodiment.

The lamp 100 may be, for example, a high-pressure mercury vapor lamp. The lamp 100 includes a glass tube for the lamp 50, a first electrode 30, a second electrode 31, a first terminal 32, a second terminal 33, and an internal space 34. The glass tube for lamp 50 includes, as shown in FIG. 2, a glass section 10 and a ceramics film 12.

The glass section 10 is in a tubular configuration that opens at upper and lower ends thereof in the figure. In a plan view, for example, as shown in FIG. 1, the glass section 10 in a first area 20 has a diameter greater than a diameter of the glass section 10 in other areas (hereafter also referred to as “second areas”) 22.

The first area 20 is generally located in the center of the glass section 10 along its longitudinal direction. The second areas 22 are located on both sides of the first area 20 in the longitudinal direction of the glass section 10. The glass section 10 in the first area 20 may be, for example, in a spherical shape, an elliptic spherical shape, or the like. The glass sections 10 in the second areas 22 are formed in a pair on both sides of the glass section 10 of the first area 20, and continuous from the glass section 10 of the first area 20. The glass sections 10 in the second areas 22 may be each formed, for example, in a circular column tube, a rectangular column tube or the like. The glass sections 10 may be formed from, for example, quartz glass.

The ceramics film 12 covers at least a portion of the inner surface of the glass section 10 in the first area 20. For example, as illustrated, the ceramics film 12 may entirely cover the inner surface of the glass section 10 in the first area 20 and the second areas 22. The film thickness of the ceramics film 12 in the first area 20 and the second areas 22 may be, for example, as illustrated, smaller than the film thickness of the glass section 10 in the first area 20 and the second areas 22.

The ceramics film 12 may include, for example, at least one of a compound material of boron nitride and silicon nitride (hereafter also referred to as “BN—SiN”), a compound material of boron oxinitride and silicon oxinitride (hereafter also referred to as “BON—SiON”), magnesium oxide (MgO), and yttrium oxide (Y₂O₃). For example, the devitrification temperature of BN—SiN, BON—SiON, MgO and Y₂)₃ is over 1500° C. BN—SiN may be expressed, for example, by a general formula, (BN)ₓ (Si₃N₄)₁₋ₓ where 0<x<1. SiON—BON may be expressed, for example, by a general formula, (SiO_{y}N_{1-y})ₓ(BO_{z}N_{1-z}, where 0<x<1, 0<y<1, and 0<z <1.

The ceramics film 12 may have a single-layer structure composed of one of BN—SiN, BON—SiON, MgO and Y₂O₃. Also, the ceramics film 12 may have a multilayer structure of laminated multiple layers composed of materials including BN—SiN, BON—SiON, MgO and Y₂O₃.

An internal space 34 is provided inside the ceramics film 12 in the first area 20. For example, mercury, rare gas, and halogen are enclosed in the internal space 34. A first electrode 30 and a second electrode 31 are disposed inside the internal space 34. The first electrode 30 and the second electrode 31 are electrodes for discharging. The first electrode 30 and the second electrode 31 may be formed from, for example, tungsten. The first electrode 30 is electrically connected to a first terminal 32 through a metal foil (not shown) sealed inside the ceramics film 12 in the second region 22. Similarly, the second electrode 31 is electrically connected to a second terminal 33. The first terminal 32 and the second terminal 33 are power supply terminals, and are lead out from both ends of the glass tube for lamp 50.

The lamp 100 in accordance with the present embodiment is applicable, for example, to devices that use light emitted by plasma radiation within the glass tube for lamp 50 (for example, projector lamps, fluorescent tubes and the like). Also, the lamp 100 may be, for example, a metal halide lamp or a xenon lamp, without being limited to a high-pressure mercury lamp.

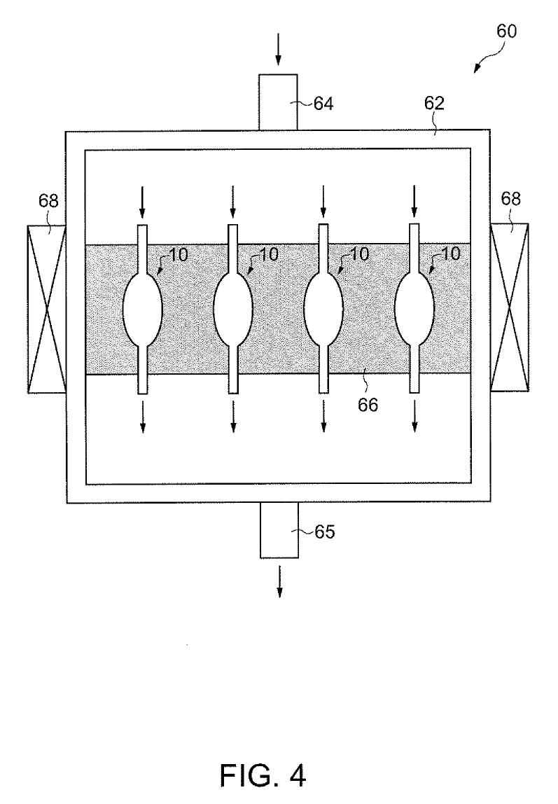

2. Next, a method for manufacturing a glass tube for lamp 50 in accordance with an embodiment of the invention is described with reference to FIGS. 2-4. FIG. 2 and FIG. 3 are cross-sectional views schematically showing a process for manufacturing the glass tube for lamp 50 in accordance with the present embodiment, and FIG. 4 is a schematic view showing a manufacturing process for manufacturing the glass tube for lamp 50 in accordance with the present embodiment. It is noted that FIG. 4 is also a schematic diagram showing an apparatus for manufacturing glass tubes for lamp in accordance with an embodiment of the invention.

(A) First, as shown in FIG. 3, a tubular glass section 10 that opens at upper and lower ends thereof in the figure is prepared.

(B) Then, as shown in FIG. 2 and FIG. 4, a ceramics film 12 is formed by a CVD method (chemical vapor deposition) method. The ceramics film 12 is formed in a manner to cover at least a portion of an inner surface of the glass section 10 in a first area 20. The CVD) method may be, for example, a thermal CVD method, a plasma CVD method (including a high-density plasma CIVD method) and the like. The ceramics film 12 may be formed by using an apparatus for manufacturing glass tubes for lamp 60, as shown in FIG. 4. The apparatus for manufacturing glass tubes for lamp 60 includes a chamber 62, a supply port 64, a discharge port 65, a support section 66, and a heater section 68.

First, as shown in FIG. 4, glass sections 10 are set by the support section 66 within the chamber 62. As the support section 66, a commonly known support unit may be used, and the glass sections 10 can be supported by a commonly known supporting device.

Then, raw material gas is supplied through the supply port 64 in the chamber 62. If necessary, for example, carrier gas, such as, for example, nitrogen (N₂), oxygen (O₂) or the like can be supplied together with the raw material gas. Also, if necessary, carrier gas can be supplied as a part of the raw material gas. As the raw material gas, for example, for forming the ceramics film 12 composed of BON—SiON, for example, tris(trimethylsiloxy) borate may be used. Also, as the raw material gas, for example, for forming the ceramics film 12 composed of MgO, for example, bis (6-ethyl-2,2-dimethyl-3,5-decanodionate) magnesium (Mg (EDMDDO₂) may be used. Also, as the raw material gas, for example, for forming the ceramics film 12 composed of Y₂O₃, for example, tris (sec-butylcyclopentadienyl) yttrium (Y(sBuCp)₃) may be used.

The inside of the chamber 62 is heated by the heater section 68, and the glass sections 10 are also heated. As the reactive gas is flown inside the heated glass sections 10, the ceramics film 12 that covers the inner surface of the glass section 10 is formed, as shown in FIG. 2. In other words, the ceramics film 12 is formed by a thermal CVD method.

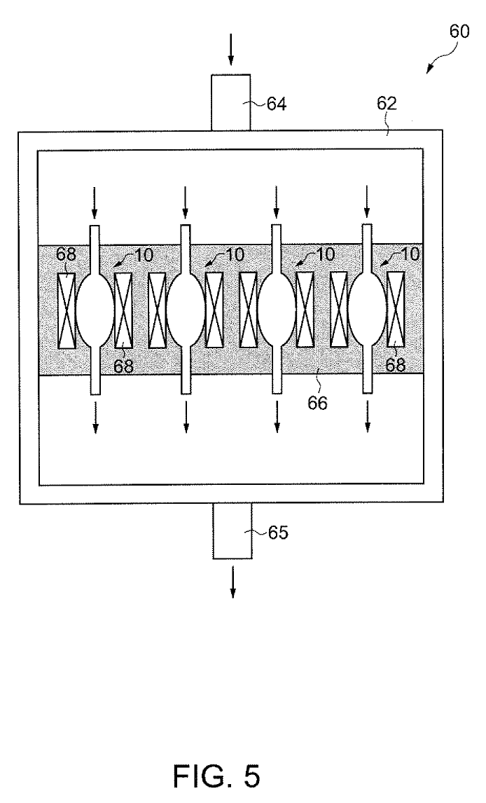

It is noted that, in the example illustrated in FIG. 4, the heater section 68 is disposed outside the chamber 62. However, in accordance with a modified example, for example, as shown in FIG. 5, the heater section 68 may be disposed inside the chamber 62. In this case, the heater section 68 can heat a desired section of the glass section 10. For example, the heater section 68 can mainly heat the glass section 10 in the first area 20, such that the ceramics film 12 can be formed on the inner surface of the glass section 10 mainly in the first area 20. It is noted that FIG. 5 is a schematic diagram showing the apparatus for manufacturing glass tubes for lamp 60 in accordance with the modified example.

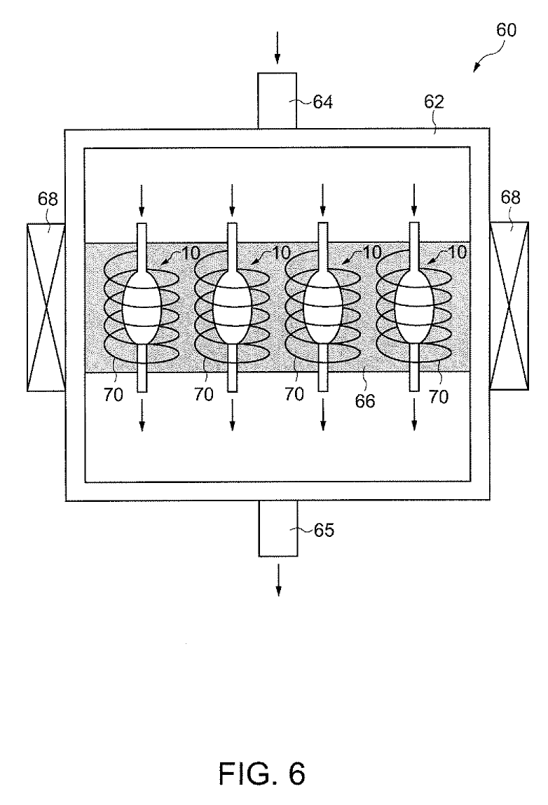

Also, in accordance with another modified example, for example, as shown in FIG. 6, an electromagnetic induction coil may be wound around a desired area of each of the glass sections 10, and the ceramics film 12 can be formed on the inner surface of the glass section 10 in a desired area by an ECR (electron cyclotron resonance) plasma CVD method. It is noted that FIG. 6 is a schematic diagram showing the apparatus for manufacturing glass tubes for lamp 60 in accordance with the modified example.

It is noted that the modified examples described above are merely examples, and the invention is not limited to these modified examples.

By the process described above, the glass tube for lamp 50 in accordance with the present embodiment is manufactured.

3. In the present embodiment, the entire inner surface of the glass section 10 in the first area 20 is coated with the ceramics film 12. By this, adhesion of impurities to the inner surface of the glass section 10 can be prevented, and the devitrification temperature of the glass section 10 can be prevented from lowering. Accordingly, in accordance with the present embodiment, the service life of the lamp 100 can be extended. It is noted that, according to the present embodiment, by covering at least a portion of the inner surface of the glass section 10 in the first area 20 with the ceramics film 12, the service life of the lamp 100 can be extended.

Also, in accordance with the present embodiment, the inner surface of the glass section 10 can be covered by the ceramics film 12 formed from a thin film. More specifically, in accordance with the present embodiment, the ceramics film 12 can be made thin. For example, the film thickness of the ceramics film 12 in at least the first area 20 can be made smaller than the film thickness of the glass section 10 in the first area 20. Therefore, in accordance with the present embodiment, for example, when the light transmittivity of the ceramics film 12 is lower than that of the glass section 10 in the same film thickness, the light transmittivity of the glass tube for lamp 50 in the first area 20 can be prevented from lowering, while the service life of the lamp 100 can be extended, as described above.

4. Although the embodiments of the invention are described in detail above, it can be readily understood by a person having ordinary skill in the art that many modifications can be made without departing in substance from the novel matter and effects of the invention. Accordingly, all of these modified examples are deemed included in the scope of the invention.

What is claimed is:

1. A glass tube for lamp, comprising:
a tubular glass section having open ends; and
a ceramics film that covers at least a portion of an inner surface of the glass section in an area that forms a light emission section of the lamp.

2. A glass tube for lamp according to claim 1, wherein the ceramics film includes at least one of a compound material of boron nitride and silicon nitride, a compound material of boron oxinitride and silicon oxinitride, magnesium oxide, and yttrium oxide.

3. A glass tube for lamp according to claim 1, wherein the ceramics film entirely covers the inner surface of the glass section in the area that forms the light emission section.

4. A glass tube for lamp according to claim 1, wherein the glass section in the area that forms the light emission section has a diameter that is greater than a diameter of the glass section on other areas.

5. A glass tube for lamp according to claim 4, wherein the ceramics film entirely covers the inner surface of the glass section in the other areas.

6. A glass tube for lamp according to claim 1, wherein the ceramics film in the area that forms the light emission section has a film thickness that is smaller than a film thickness of the glass section in the area that forms the light emission section.

7. A lamp comprising the glass tube for lamp set forth in claim 1.

8. A method for manufacturing a glass tube for lamp, the method comprising the steps of:
preparing a tubular glass section that opens on both ends thereof and
forming by a CVD method a ceramics film that covers at least a portion of an inner surface of the glass section in an area that forms a light emission section of the lamp.

9. A method for manufacturing a glass tube for lamp according to claim 8, wherein the CVD method is one of a thermal CVD method and a plasma CVI) method.

10. A method for manufacturing a glass tube for lamp according to claim 8, wherein the CVD method uses at least one of bis (6-ethyl-2,2-dimethyl-3,5-decanodionate) magnesium, tris (sec-butylcyclopentadienyl) yttrium, and tris(trimethylsiloxy) borate as a raw material gas.
